(19) United States
(12) Patent Application Publication
(10) Pub. No.: US 2026/0301193 A1
(43) Pub. Date: Oct. 1, 2026

(54) TRACKING DEVICE, TRACKING METHOD, AND STORAGE MEDIUM STORING TRACKING PROGRAM

(71) Applicants: DENSO CORPORATION, Kariya-city, Aichi-pref. (JP); J-QuAD DYNAMICS Inc., Chuo-ku, Tokyo (JP)

(72) Inventors: Koichiro SUZUKI, Tokyo (JP); Yuto TANIGUCHI, Tokyo (JP); Takuma YAMAUCHI, Tokyo (JP)

(21) Appl. No.: 19/567,768

(22) Filed: Mar. 16, 2026

(30) Foreign Application Priority Data
Mar. 19, 2025 (JP) 2025-045860

(51) Int. Cl. G06T 7/20; G01S 13/86; G01S 13/89; G06V 10/20; G06V 10/44; G06V 10/80; G06V 20/52

(52) U.S. Cl. CPC G06T 7/20; G01S 13/867; G01S 13/89; G06V 10/255; G06V 10/44; G06V 10/803; G06V 20/52; G06T 2207/10028; G06T 2207/20076; G06V 2201/07

(57) ABSTRACT

A tracking device is configured to: track a target object based on an image of the target object captured by an image sensor and a point cloud of an observation point at which the target object is observed by a radar to estimate a target object state; calculate a prediction target object state by predicting the target object state at a second time later than a first time; calculate an image update target object state by updating the prediction target object state using a first likelihood; and update the image update target object state using a second likelihood.

### CROSS REFERENCE TO RELATED APPLICATION

The present application claims the benefit of priority from Japanese Patent Application No. 2025-045860 filed on Mar. 19, 2025. The entire disclosure of the above application is incorporated herein by reference.

### TECHNICAL FIELD

The present disclosure relates to a technology for tracking a target object.

### BACKGROUND

A technology for tracking a target object based on an image obtained by an image sensor has been known as a comparative example.

### SUMMARY

According to an aspect of the present disclosure, a tracking device comprises at least one of (i) a circuit and (ii) a processor with a memory storing computer program code executable by the processor. The at least one of the circuit and the processor may cause the tracking device to: track a target object based on an image of the target object captured by an image sensor and a point cloud of an observation point at which the target object is observed by a radar to estimate a target object state; calculate a prediction target object state by predicting the target object state at a second time later than a first time; calculate an image update target object state by updating the prediction target object state using a first likelihood; and update the image update target object state using a second likelihood.

### BRIEF DESCRIPTION OF DRAWINGS

FIG. 1 is a diagram showing a schematic configuration of a sensor system.

FIG. 2 is a diagram showing a configuration of a tracking device.

FIG. 3 is a diagram illustrating a coordinate system and parameters used for estimating a target object state.

FIG. 4 is a flowchart showing an example of an update process using an image.

FIG. 5 is a diagram illustrating an edge bearing.

FIG. 6 is a graph schematically showing a case where bearing is not normalized.

FIG. 7 is a graph schematically showing a case where the bearing is normalized.

FIG. 8 is a flowchart showing one example of an update process by a radar point cloud.

FIG. 9 is a diagram illustrating a correspondence hypothesis.

FIG. 10 is a diagram illustrating a reflection position assumed for each hypothesis.

FIG. 11 is a diagram illustrating an example of an update process.

FIG. 12 is a diagram illustrating a pseudo-rectangular shape of an outline model.

### DETAILED DESCRIPTION

By fusing sensor data from multiple types of sensors, it has been attempted to improve tracking accuracy of target objects. When the image of the image sensor and the point cloud of an observation point of the radar are combined, the observation point of the radar may include a large amount of clutter. Therefore, it becomes difficult to generate the initial value of the tracker. Therefore, there is a difficulty in implementing robust tracking by fusing image sensors and radars.

One example of the present disclosure provides a tracking device, a tracking method, and a tracking program that implement robust tracking by fusing an image sensor and a radar.

According to an aspect of the present disclosure, a tracking device comprising at least one processor configured to: track a target based on an image of the target captured by an image sensor and a point cloud of an observation point at which the target is observed by a radar to estimate a target state; calculate a prediction target state by predicting the target state at a second time later than a first time based on an estimation result of the target state at the first time; calculate an image update target state by updating the prediction target state using a likelihood based on a recognition result of the image; and update the image update target state with a second likelihood based on the point cloud to obtain an estimation result of the target state at the second time.

According to another aspect of the present disclosure, a tracking method comprising: tracking a target based on an image of the target captured by an image sensor and a point cloud of an observation point at which the target is observed by a radar to estimate a target state; calculating a prediction target state by predicting the target state at a second time later than a first time based on an estimation result of the target state at the first time; calculating an image update target state by updating the prediction target state using a likelihood based on a recognition result of the image; and updating the image update target state with a second likelihood based on the point cloud to obtain an estimation result of the target state at the second time.

Further, according to another aspect of the present disclosure, a computer-readable storage medium stores a tracking program configured to cause at least one processor to: track a target based on an image of the target captured by an image sensor and a point cloud of an observation point at which the target is observed by a radar to estimate a target state; calculate a prediction target state by predicting the target state at a second time later than a first time based on an estimation result of the target state at the first time; calculate an image update target state by updating the prediction target state using a first likelihood based on a recognition result of the image; and update the image update target state with a second likelihood based on the point cloud to obtain an estimation result of the target state at the second time.

According to these aspects, the likelihood for fusing the image and the point cloud can be designed as a product of the likelihood based on the recognition result of the image and the likelihood based on the point cloud of the observation point. Therefore, it is possible to rationally obtain the target object state from different types of sensors. Then, among the image by the image sensor and the point cloud of the radar observation point, the prediction target object state is updated first based on the recognition result of the image by the image sensor. Since the image recognition result has less noise such as clutter than the point cloud of observation points of the radar, it is easy to specify the association between the prediction target object state and the target object to be tracked. Then, after the association is clarified using the image, the update is performed using the point cloud of the observation point of the radar. Therefore, it is possible to implement robust tracking.

In the present disclosure, the term “processor” refers to a processor as a single piece or a plurality of pieces of hardware, and is configured to read a computer program code included in the computer program (i.e., one or more commands of the computer program) each time to execute processing defined by the computer program code. In other words, the “processor” is a hardware device that executes one or more programmed processes. Therefore, the computer program code can also be referred to as software capable of defining the processing of the processor in accordance with the content thereof. For example, the “processor” is a general purpose or specific purpose processor, and may be a CPU, a microprocessor, a graphics processing unit (GPU), a data flow processor (DFP), or the like, but is not limited thereto.

In the present disclosure, the term “memory” refers to one or more hardware memories that are non-transitory tangible storage media configured to store computer program code and/or data accessible to a processor. The “memory” may be implemented with memory technologies such as SRAM, SDRAM, non-volatile/flash type memory, or other types of memory. The computer program code constituting the program is recorded in the memory and executed by the processor, so that the processor can implement the various functions described above.

In the present disclosure, the term “circuit” refers to a logic circuit as a single piece or a plurality of pieces of hardware, and is configured to execute specific processing defined based on a pre-designed circuit configuration. In other words, (and in contrast to “processor”), the “circuit” in the present disclosure refers to a hardware device that executes specific processing based on a circuit configuration, rather than processing defined by software such as the above-mentioned computer program code. For example, the “circuit” may include a custom integrated circuit (IC), such as an application-specific integrated circuit (ASIC) or a field-programmable gate array (FPGA), designed using a hardware description language (HDL). That is, the “circuit” in the present disclosure includes all hardware circuits except for the above-mentioned processor that executes processing by reading computer program code.

In the present disclosure, the expression “at least one of the circuit or the processor” should be interpreted in the disjunctive sense (logical sum), and not as at least one circuit and at least one processor.

In the present disclosure, the term “processor” means a hardware device that executes a process by a “processor”, a “circuit”, or a combination thereof. The “processor” may mean the “processor” itself when the function is not implemented by the “circuit”. If the function is interpreted to be implemented by the “processor”, the function means the “processor” itself.

The following will describe embodiments of the present disclosure with reference to accompanying drawings. It is noted that the same reference numerals are attached to the corresponding constituent elements in each embodiment, and redundant explanation may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of multiple embodiments can be partially combined even when they are not explicitly shown as long as there is no difficulty in the combination in particular.

### First Embodiment

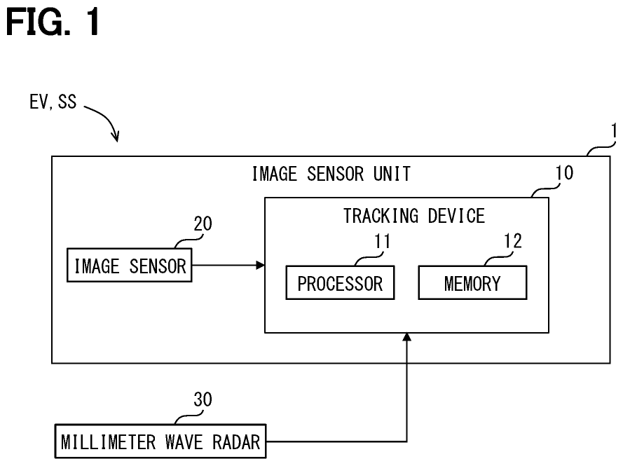

A tracking device 10 shown in FIG. 1 is provided in a sensor system SS of a vehicle EV. The tracking device 10 implements extended object tracking (EOT) that recognizes the target object, and performs tracking processing. The tracking device 10 estimates a target object state such as, for example, position, velocity, size, and the like in chronological order from the observation data obtained by observing the target object. For example, the tracking device 10 may be an ECU provided in an image sensor unit 1 mounted on a vehicle (hereinafter referred to as a subject vehicle). The ECU is an abbreviation for Electronic Control Unit.

The image sensor unit 1 includes the tracking device 10 and an image sensor 20. The image sensor 20 is installed, for example, inside the upper end of a front windshield of the vehicle EV, and captures the front of the vehicle EV from inside the vehicle EV. The image sensor 20 is, for example, a camera, and includes an optical system that forms an image of light in the external environment and a light reception element that receives light concentrated by the optical system such as a CMOS sensor or a CCD sensor. The image sensor 20 sequentially generates color images or monochrome images and provides image data to the tracking device 10.

The tracking device 10 receives point cloud data from a millimeter wave radar 30. The millimeter wave radar 30 is a radar device placed at the front end of the vehicle EV, for example, at the center of the front bumper, the back side of the emblem, or the like. The millimeter wave radar 30 irradiates a millimeter wave or a quasi-millimeter wave toward the front of the vehicle EV, that is, a range where the detection range of the image sensor 20 at least partially overlaps. The millimeter wave radar 30 receives reflected waves reflected on target objects, and sequentially provides point cloud data of observation points indicating the reflection positions to the tracking device 10.

The tracking device 10 mainly includes a computer. The computer constituting the tracking device 10 has at least one processor 11 and at least one memory 12. The processor 11 may be, for example, a CPU, or may be another type of processor (for example, a GPU). The processor of the present embodiment corresponds to a processing unit that executes the process.

The memory 12 is a non-transitory tangible storage medium that non-temporarily stores computer programs and data such as, for example, a read only memory (ROM). The memory 12 may include, for example, a rewritable volatile storage medium such as a random access memory (RAM). The RAM may be used for temporary storage of data during processing. The processor 11 is configured to read a computer program stored in the memory 12 and can execute various processes according to the computer program.

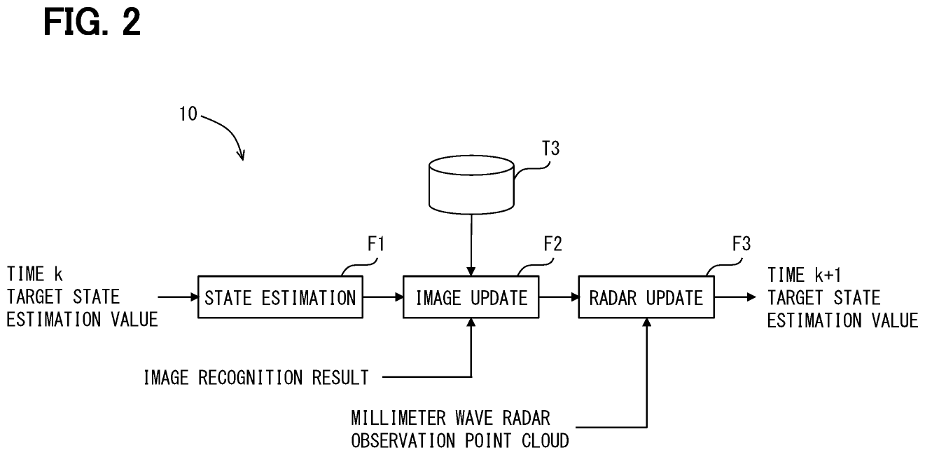

As shown in FIG. 2, the tracking device 10 includes a state prediction unit F1, an image update unit F2, and a radar update unit F3 as functional units whose functions are implemented by the processor 11 executing a computer program stored in the memory 12. The tracking device 10 repeatedly executes a series of processes by the state prediction unit F1, the image update unit F2, and the radar update unit F3 for each process cycle, and sequentially updates the estimated target object state to the latest state. The processing cycle referred to here does not need to be divided into equal time intervals. Variations in processing time may occur for each cycle.

The state prediction unit F1 calculates a prediction target object state by predicting the target object state at a second time later than a first time based on an estimation result of the target object state at the first time. Here, the estimation result of the target object state at the first time point may be the target object state estimated by the process of the preprocessing cycle. Hereinafter, the description will continue with the first time as k and the second time as k+1. One time, which is the difference between the first time point and the second time point, substantially corresponds to one processing cycle.

Here, parameters for describing the target object state will be described. Note that the description method of the parameters described here is merely an example, and can be changed within the scope that does not depart from the gist.

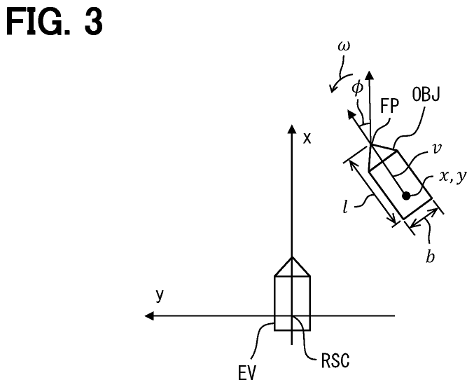

As shown in FIG. 3, an xy coordinate system is set with a rear wheel axle center RSC of the subject vehicle EV as the coordinate center. An xy plane in the xy coordinate system can be set in a direction along the horizontal plane. The coordinate center may be set to another position. However, when the rear wheel axle center RSC is set to the coordinate center, a turning center of the subject vehicle EV whose front wheels are steering wheels substantially coincides with the coordinate center. Therefore, it may be possible to avoid complicating the calculation of the target object state described later.

The position of the turning center (for example, the center of the rear wheel axle) of a target object OBJ to be tracked is (x, y) [m]. The velocity of the target object OBJ is set to v [m/s], the direction of the target object OBJ is set to φ [rad], and the angular velocity of the target object OBJ is set to ω [rad/s]. Furthermore, the size of the target object OBJ is expressed by a major-axis dimension I [m] and a minor-axis dimension b [m]. The ratio between the major-axis dimension I and the length from a target object tip FP along the major-axis to the turning center is expressed by d. The d is also referred to as a center position parameter for indicating the turning center position of the target object OBJ.

The true value of the target object state of the target object OBJ at time k is expressed by the following first equation. In the first equation, the upper left subscript “T” represents the transposed matrix. The same applies to the following other mathematical equations and expressions unless otherwise specified.

$${ξ}_{k} = {[ {( {ξ}_{k}^{k} )}^{T} , {( {ξ}_{k}^{g} )}^{T} ]}^{T} \qquad ( First Equation )$$

The motion parameter of the first equation is expressed as the following second equation. The motion parameter is a parameter for expressing the motion of the target object OBJ.

$${ξ}_{k}^{k} = {[ x , y , v , ϕ , ω ]}^{T} \qquad ( Second Equation )$$

The geometric parameter of the first equation is expressed as the following third equation. The geometric parameter is a parameter for expressing geometric elements such as the size of the target object OBJ.

$${ξ}_{k}^{g} = {[ l , b , d ]}^{T} \qquad ( Third Equation )$$

Next, a tracker prediction value set for expressing the target object state predicted for the target object OBJ will be described. The target object state during tracking is expressed as the following fourth equation under the assumption that the average is a true value and the variance follows a known Gaussian distribution. In the fourth equation, N indicates that the distribution follows a normal distribution.

$${ξ}_{k \vert k} ∼ N ( {ξ}_{k} , {P}_{k \vert k} ) , {P}_{k \vert k} = [ \begin{matrix}{P}_{k \vert k}^{k} & 0 \\ 0 & {P}_{k \vert k}^{g}\end{matrix} ] \qquad ( Fourth Equation )$$

The parameter used in the fourth equation and shown in a fifth expression is an estimation error variance covariance matrix indicating the error, variance, and covariance estimated for the motion parameter.

$${P}_{k \vert k}^{k} \qquad ( Fifth Equation )$$

The parameter used in the fourth equation and shown in a sixth expression is an estimation error variance covariance matrix of the geometric parameter.

$${P}_{k \vert k}^{g} \qquad ( Sixth Equation )$$

At time k, it is assumed that the set of pairs of the state estimation value and the variance covariance matrix shown in the following seventh equation has been obtained. The upper right subscripts 1, 2, . . . , Nk in the set element are indices of the tracker, and match indices in the image recognition result set described later.

$${Ξ}_{k \vert k} = \{ [ {ξ}_{k \vert k}^{1} , {P}_{k \vert k}^{1} ] , [ {ξ}_{k \vert k}^{2} , {P}_{k \vert k}^{2} ] , … , [ {ξ}_{k \vert k}^{{N}_{k}} , {P}_{k \vert k}^{{N}_{k}} ] \} \qquad ( Seventh Equation )$$

At this time, the tracker prediction value set is expressed as the following eighth equation.

$${Ξ}_{k + 1 \vert k} = \{ [ {\overline{ξ}}_{k + 1}^{1} , {M}_{k + 1}^{1} ] , [ {\overline{ξ}}_{k + 1}^{2} , {M}_{k + 1}^{2} ] , … , [ {\overline{ξ}}_{k + 1}^{{N}_{k}} , {M}_{k + 1}^{{N}_{k}} ] \} \qquad ( Eighth Equation )$$

The state prediction unit F1 calculates the tracker prediction value set as follows. The state prediction unit F1 calculates the average prediction value for calculating the target object state at time k+1 using the motion model and the error variance covariance matrix by the following ninth equation.

$${\overline{ξ}}_{k + 1} ∼ N ( {ξ}_{k + 1} , {M}_{k + 1} ) \qquad ( Ninth Expression )$$

However, each parameter used in the ninth expression is indicated by tenth, eleventh, twelfth, and thirteenth equations.

$${\overline{ξ}}_{k + 1} = {f}_{C T R V} ( {ξ}_{k \vert k} , 0 ) \qquad ( Tenth Equation )$$

$${M}_{k + 1} = [ \begin{matrix}{M}_{k + 1}^{k} & 0 \\ 0 & {M}_{k + 1}^{g}\end{matrix} ] \qquad ( Eleventh Equation )$$

$${M}_{k + 1}^{k} = {F}_{k} {P}_{k \vert k}^{k} + {G}_{k} {Q}_{k} {G}_{k}^{T} \qquad ( Twelfth Equation )$$

$${M}_{k + 1}^{g} = {P}_{k \vert k}^{g} \qquad ( Thirteenth Equation )$$

Here, with respect to the tenth equation, the function shown by the fourteenth equation represents a constant turn rate and velocity (CTRV) motion model. The CTRV motion model is a motion model for describing the nonlinear motion of the target object. The CTRV motion model is a model that assumes that the target object is moving at a constant angular speed and a constant speed.

$${f}_{C T R V} ( ξ , {v}_{k} ) \qquad ( Foureenth Equation )$$

Specifically, the CTRV motion model is expressed as the following fifteenth equation.

$${f}_{C T R V} ( ξ , {v}_{k} ) = f ( ξ ) + {Gv}_{k} \qquad ( Fifteenth Equation )$$

However, each function or parameter used in the fifteenth equation is shown by sixteenth equation, seventeenth equation, and eighteenth equation.

$$( Sixteenth Equation )$$

$$f ( ξ ) = [ \begin{matrix}x + ( \frac{2 v}{ω} ) sin ( \frac{ω T}{2} ) cos ( ϕ + \frac{ω T}{2} ) \\ y + ( \frac{2 v}{ω} ) sin ( \frac{ω T}{2} ) sin ( ϕ + \frac{ω T}{2} ) \\ v \\ ϕ + ω T \\ ω \\ l \\ b \\ d\end{matrix} ]$$

$$( Seventeenth Equation )$$

$$G = [ \begin{matrix}0 & 0 \\ 0 & 0 \\ T & 0 \\ 0 & \frac{{T}^{2}}{2} \\ 0 & T \\ 0 & 0 \\ 0 & 0 \\ 0 & 0\end{matrix} ]$$

$$( Eighteenth Equation )$$

$${v}_{k} = {[ {v}_{v} , {v}_{ω} ]}^{T} ∼ N ( 0 , Q )$$

The T used in the sixteenth and seventeenth equations is an update cycle, and also corresponds to a process cycle described above. The parameter of the eighteenth equation represents process noise, and is included in the acceleration and the angular acceleration. The process noise represents errors caused by model uncertainty and unpredictable external factors. It is assumed that the process noise property is independent between the acceleration and the angular acceleration, an average is 0, and the variance is expressed by parameters shown by the nineteenth and twentieth expressions, and follows a Gaussian distribution.

$$( Nineteenth Expression )$$

$${σ}_{v}^{2}$$

$$( Twentieth Expression )$$

$${σ}_{ω}^{2}$$

That is, the Q of the eighteenth equation is expressed by the following twenty-first equation.

$$( Twenty - First Equation )$$

$$Q = diag ( [ {σ}_{v}^{2} , {σ}_{ω}^{2} ] )$$

The parameter used in the twelfth equation and shown in the following twenty-second equation is a matrix obtained by linearizing the motion model with respect to the target object state, and is shown as the following mathematical equation.

$$( Twenty - Second Equation )$$

$${F}_{k} = \frac{\partial {f}_{CTRV} ( ξ , {v}_{k} )}{\partial ξ} {\vert}_{ξ = {ξ}_{k \vert k} , {v}_{k} = 0}$$

A center position parameter d is assumed to be fixed. As a result, the geometric parameter is simplified as shown in the following twenty-third equation, and the calculation is executed including processes sequentially described below.

$$( Twenty - Third Equation )$$

$${ξ}_{k}^{g} = {[ l , b ]}^{T}$$

As described above, the state prediction unit F1 calculates a tracker prediction value set, which is a tracker set predicted at time k+1, based on the tracker set at time k. The state prediction unit F1 provides the calculated tracker prediction value set to the image update unit F2.

The image update unit F2 updates the target object state with the image. The image update unit F2 updates the prediction target object state (i.e., the tracker prediction value set) obtained by predicting the target object state at the second time using the image recognition result set. The image update unit F2 models the likelihood function from the image recognition result set, and calculates a posterior distribution of the geometric parameters.

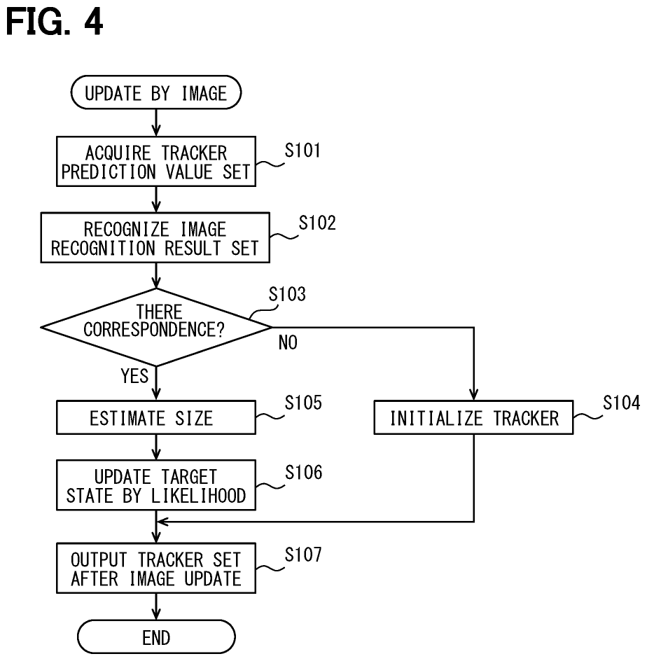

Specifically, the image update unit F2 executes the process based on the process method shown in a flowchart of FIG. 4. Hereinafter, details will be described according to S101 to S107 of the flowchart.

In the first S101, the image update unit F2 acquires the latest tracker prediction value set calculated by the state prediction unit F1. S102 may be executed after the process of S101, simultaneously with S101, or before the process of S101. In S102, the image update unit F2 recognizes the latest image recognition result set. This image recognition result set may be recognized by calculation by the image update unit F2, or may be acquired from another functional unit of the tracking device 10 or from the outside of the tracking device 10.

Here, the image recognition set will be described in detail. First, the image recognition result (however, z is lowercase) of recognizing the target object OBJ reflected in the image data is defined as the following twenty-fourth equation.

$$( Twenty - Fourth Equation )$$

$${z}_{k}^{i m} = {[ i , {f}_{r} , {f}_{l} , {r}_{r} , {r}_{l} , x , y , v , ϕ , c ]}^{T}$$

In the twenty-fourth equation, the i is the index of the target object, and a number is assigned to each target object. The index is assumed to assign the same sequential number to the same target object regardless of the observation time.

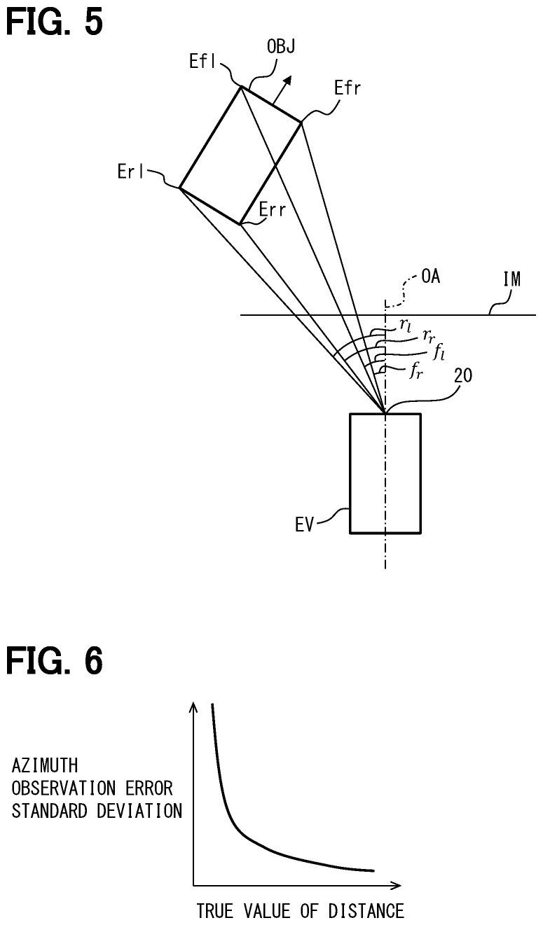

The four parameters of fᵣ, fₗ, rᵣ, and rᵢ [rad] are edge bearings corresponding to the four edges Efr, Efl, Err, and Erl of the target object OBJ shown in FIG. 5. The edge Efr is the right front edge of the target object OBJ. The edge Efl is the left front edge of the target object OBJ. The edge Err is the right rear edge of the target object OBJ. The edge Erl is the left rear edge of the target object OBJ.

The edge bearing is a bearing of each edge Efr, Efl, Err, and Erl with respect to the position of the image sensor 20. The edge bearing is an angle from the position of the image sensor 20 to the target edge with respect to the optical axis of the image sensor 20. The edge bearing can be calculated by perspective projection, for example, and can be estimated from a position of a pixel in which the edge is reflected in an image IM.

The four edges Efr, Efl, Err, and Erl of the target object OBJ may not be all reflected in the image IM. The edge bearing of edges that are not reflected in the image IM is assumed to have no value. At this time, the edge bearing may be estimated using an estimation method such as stereo depth estimation or monocular depth estimation.

The φ is the direction of the subject vehicle EV. The c is a recognition result class. The recognition result class indicates the type of target object, such as, for example, a vehicle, a pedestrian, or a fallen object.

At this time, the image recognition result set (however, Z is capitalized) is defined as the following twenty-fifth equation.

$$( Twenty - Fifth Equation )$$

$${Z}_{k}^{i m} = \{ {z}_{k}^{i m , 1} , {z}_{k}^{i m , 2} , … , {z}_{k}^{i m , {L}_{k}} \}$$

In S103 after the processes of S101 and S102, the image update unit F2 associates the tracker prediction value set with the image recognition result set, and determines whether the association of the target object OBJ exists between the two sets.

Specifically, the index of the tracker prediction value set automatically corresponds to the index assigned by the tracker initialization (details will be described later) before the previous cycle. The image update unit F2 refers to this correspondence relationship to confirm the association between the tracker prediction value set and the image recognition result set used for the current update. A case where there is no association includes a case where the target object OBJ reflected at the time of the previous initialization is no longer reflected by the image IM due to being shielded or moving out of the frame of the image IM. Further, the case where there is no association includes a case where the target object OBJ that was not reflected at the time of the previous initialization is reflected due to moving into the frame of the image IM.

When it is determined that the target object OBJ is associated between the two sets, the process proceeds to S105. When it is determined that there is no association of the target object OBJ between the two sets, the process proceeds to S104.

In S104, the image update unit F2 initializes the tracker. Here, the initialization means to change the index of the tracker prediction value set to the index of the image recognition result set used for the current update.

Specifically, when the set of image recognition results with the association is expressed by the following twenty-sixth expression, the image update unit F2 initializes the image recognition results without the association expressed by the twenty-seventh expression.

$$( Twenty - Sixth Expression )$$

$${Z}_{k}^{im , A}$$

$$( Twenty - Seventh Expression )$$

$${z}_{k}^{i m} ∉ {Z}_{k}^{im , A}$$

Here, it has been found that, in image recognition, the accuracy of the distance represented by a twenty-eighth expression with respect to the position of the rear wheel axle center RSC of the subject vehicle EV is relatively poor.

$$( Twenty - Eighth Expression )$$

$$\sqrt{{x}^{2} + {y}^{2}}$$

Therefore, in the initialization, the image update unit F2 shifts the distance within a preset distance range, and sets a position corresponding to the distance to the center, and counts the number of image recognition points entering the preset region. The image update unit F2 sets the position with the largest number of image recognition points entering the region to the initial tracker position. Furthermore, the image update unit F2 initializes the speed and the target object size based on the image recognition result. The image update unit F2 initializes the angular velocity to 0.

Then, the image update unit F2 initializes the ratio d between the major-axis dimension I and the length from the target object tip FP along the major-axis to the center of the turn to 0.5. At the initialization stage, the direction of the newly reflected target object OBJ is often not determined. Therefore, by setting the d to 0.5, which is a value corresponding to the center position of the target object OBJ, it may be possible to perform initialization so that no large error occurs regardless of which side of the major-axis direction the front of the target object OBJ is.

On the other hand, in S105 when it is determined that there is the association, the image update unit F2 estimates the size of the target object OBJ. First, the image update unit F2 assumes that the n-th tracker prediction value and the n-th prediction error variance covariance matrix represented by the following twenty-ninth expression correspond to the edge bearing represented by the following thirtieth expression.

$$( Twenty - Ninth Expression )$$

$$[ {\overline{ξ}}_{k + 1}^{n} , {M}_{k + 1}^{n} ]$$

$$( Thirtieth Expression )$$

$${z}_{k}^{im , n}$$

Then, the image update unit F2 updates the geometric parameter represented by a thirty-second expression and the prediction error covariance matrix represented by a thirty-third expression in tracker prediction values represented by a thirty-first expression.

$$( Thirty - First Expression )$$

$${\ddot{ξ}}_{k + 1}^{n}$$

$$( Thirty - Second Expression )$$

$${\overline{ξ}}_{k + 1}^{g , n}$$

$$( Thirty - Third Expression )$$

$${M}_{k + 1}^{g , n}$$

By this update, the image update unit F2 obtains the updated geometric parameter represented by a thirty-fourth expression and the updated prediction error covariance matrix represented by a thirty-fifth expression.

$$( Thirty - Fourth Expression )$$

$${ξ}_{k + 1 \vert k + 1}^{g , n}$$

$$( Thirty - Fifth Expression )$$

$${P}_{k + 1 \vert k + 1}^{g , n}$$

The edges Efr, Efl, Err, and Erl of the target object OBJ on the image IM can be stably and accurately detected as compared with the distance shown in the twenty-eight equation. As shown in FIG. 5, the edge bearing observed in the image IM in which the target object OBJ exists depends on the position and the direction of the target object OBJ. Normally, as described above, the edge bearings of three edges (Efr, Err, Erl in FIG. 5) other than the edge hidden behind (Efl in FIG. 5) are observed. On the other hand, when the direction of the target object OBJ substantially matches the front direction of the image IM, the sensitivity of the target object OBJ for the dimensions I, b becomes abnormally large. The abnormally large sensitivity means that it is difficult to estimate the geometric parameter. Hereinafter, it is assumed that the sensitivity of the geometric parameter of the target object OBJ is not abnormal, and the description will continue.

The image update unit F2 calculates the normalization bearings obtained by normalizing the three edge bearings, and performs the size estimation by updating the state with a Kalman filter using the normalization bearings. Hereinafter, the normalization bearing may be referred to as a cross-range bearing.

That is, the image update unit F2 provides the prior distribution with a Gaussian distribution with the prediction value of the geometric parameter and the prediction error variance covariance as parameters, and models the four edge bearings when the target object OBJ on the xy plane is observed by the image IM as the likelihood function. Thereby, the image update unit F2 obtains the posterior distribution of the geometric parameters. At this time, the image update unit F2 does not update the motion parameter, and only updates the geometric parameter.

Hereinafter, details of estimating the geometric parameters will be described. The prior distribution of the geometric parameters is given by a thirty-sixth expression.

$$( Thirty - Sixth Expression )$$

$${ξ}_{k + 1}^{g , n} ∼ N ( {\overline{ξ}}_{k + 1}^{g ,} , {M}_{k + 1}^{g , n} )$$

Next, the observation and the likelihood function will be described. First, the image update unit F2 obtains the cross-range bearing by correcting the edge bearings of the four edges Efr, Efl, Err, and Erl of the target object OBJ by the distance. The image update unit F2 calculates the geometric parameter likelihood using the cross-range bearing.

A specific edge among the four edges is defined as e. Among the image observations shown in the thirty-seventh equation, the four parameters shown in the thirty-eighth expression are edge bearings. However, among the four parameters, the edge bearing corresponding to the e is replaced by a parameter represented by a thirty-ninth expression. For example, when the e is the front-right edge Efr of the target object OBJ, the parameter represented by the thirty-ninth expression is the front-right edge bearing.

$$( Thirty - Seventh Expression ) )$$

$${z}_{k + 1}^{i m} = {[ i , {f}_{r} , {f}_{l} , {r}_{r} , {r}_{l} , x , y , v , ϕ , c ]}^{T}$$

$$( Thirty - Eighth Expression ) )$$

$${f}_{r} , {f}_{l} , {r}_{r} , {r}_{l}$$

$$( Thirty - Ninth Expression )$$

$${θ}_{e}^{i m}$$

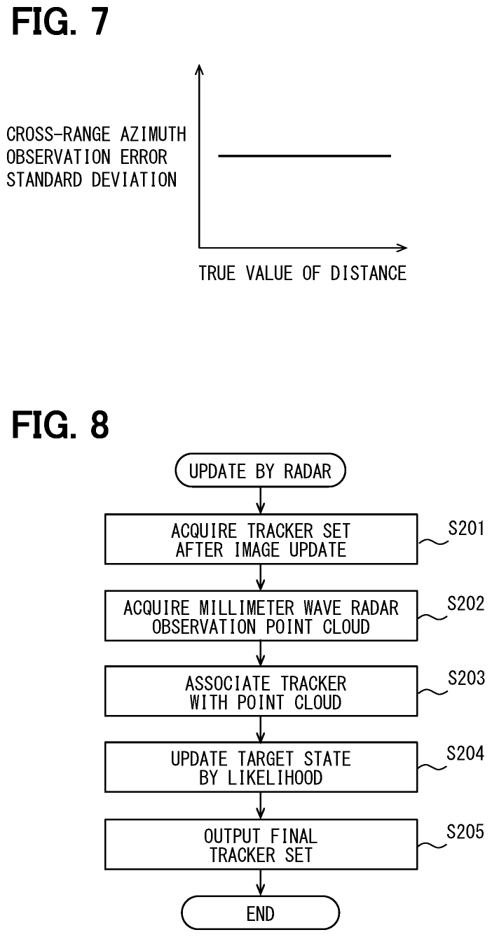

Pixel deviation in the image IM is considered as a factor causing the edge image recognition error. The pixel deviation is equivalent to the angle deviation on the image plane. However, in the rear wheel axle center RSC of the subject vehicle EV, the positional deviation amount corresponding to the pixel deviation strongly depends on the distance from the subject vehicle EV. As shown in FIG. 6, the inventors found that the observed error and standard deviation of the edge bearing are inversely proportional to the distance true value. As shown in FIG. 7, the inventors found that the error and the standard deviation of the cross-range bearing normalized by the distance are approximately constant values without depending on the distance true value.

Accordingly, the image update unit F2 uses, as the observation amount, the cross-range bearing (shown in a fortieth expression) obtained by normalizing the edge bearing. As a result, the image observation is as shown in the following forty-first equation. However, it is assumed that a forty-second equation is established.

$$( Fortieth Expression )$$

$$reg {θ}^{i m}$$

$$( Forty - First Equation )$$

$${z}^{g e o} ( {z}^{i m} ) = {[ {regf}_{r} ( {z}^{i m} ) , {regf}_{l} ( {z}^{i m} ) , {regr}_{r} ( {z}^{i m} ) , {regr}_{l} ( {z}^{i m} ) ]}^{T}$$

$$( Forty - Second Equation )$$

$$reg {θ}_{e}^{i m} ( {z}^{i m} ) = {[ {θ}_{e}^{i m} ]}_{{z}^{i m}} {‖ {[ x , y ]}_{{z}^{i m}} ‖}_{2}$$

Here, in the forty-second equation, a portion shown in a forty-third expression represents reference of a value in a parameter shown in a forty-fourth expression.

$${[ \cdot , \cdot ]}_{{z}^{im}} \qquad ( Forty - Third Expression )$$

$${z}^{im} \qquad ( Forty - Fourth Expression )$$

The projection from the state to the observation amount, that is, a observation equation is necessary for designing the likelihood function. In the observation equation shown in the following forty-fifth equation, the observation amount is a cross-range distance (also referred to as a normalized distance) corresponding to the four edges Efr, Efl, Err, and Erl of the target object OBJ. However, the function shown in a forty-sixth expression means the product of the plane coordinate values of each edge Efr, Efl, Err, and Erl on the xy plane and the distance.

$${h}^{im} ( ξ ) = [ \begin{matrix}{regf}_{r} ( ξ ) \\ {regf}_{l} ( ξ ) \\ {regr}_{r} ( ξ ) \\ {regr}_{l} ( ξ )\end{matrix} ] \qquad ( Forty - Fifth Expression )$$

$$reg \cdot \qquad ( Forty - Sixth Expression )$$

The plane coordinate value is obtained by adding an edge offset vector indicated by the forty-eighth expression to the target object position (position vector) indicated by the forty-seventh expression. The edge offset vector is a vector that offsets the turning center of the target object OBJ and converts it into an edge position.

$${[ x , y ]}_{ξ}^{T} \qquad ( Forty - Seventh Expression )$$

$${e}_{v} \qquad ( Forty - Eighth Expression )$$

Specifically, the edge offset vector with respect to the state quantity is represented by the following forty-ninth to fifty-second equations corresponding to the edges Efr, Efl, Err, and Erl.

$${f}_{{r}_{v}} = {{Rot}_{{[ ϕ ]}_{ξ}} [ ld , \frac{b}{2} ]}_{ξ}^{T} \qquad ( Forty - Ninth Expression )$$

$${f}_{{l}_{v}} = {{Rot}_{{[ ϕ ]}_{ξ}} [ ld , - \frac{b}{2} ]}_{ξ}^{T} \qquad ( Fiftieth Equation )$$

$${r}_{{r}_{v}} = {{Rot}_{{[ ϕ ]}_{ξ}} [ l ( d - 1 ) , \frac{b}{2} ]}_{ξ}^{T} \qquad ( Fifty - First Equation )$$

$${r}_{{l}_{v}} = {{Rot}_{{[ ϕ ]}_{ξ}} [ l ( d - 1 ) , - \frac{b}{2} ]}_{ξ}^{T} \qquad ( Fifty - Second Equation )$$

Here, in the forty-ninth to fifty-second equations, a portion shown by a fifty-third expression represents a two-dimensional rotation matrix, and a portion shown by a fifty-fourth equation represents a reference to a value in ξ.

$$Rot . \qquad ( Fifty - Third Equation )$$

$${[ \cdot ]}_{ξ} \qquad ( Fifty - Fourth Equation )$$

Summarizing the above, the cross-range bearing corresponding to a particular edge e is given by the following fifty-fifth equation. However, the edge e is represented by a fifty-sixth equation.

$$reg\_e = {cos}^{- 1} ( [ 10 ] \frac{( {[ x , y ]}_{ξ}^{T} + {e}_{v} )}{‖ {[ x , y ]}_{ξ}^{T} + {e}_{v} ‖} ) \cdot ‖ {[ x , y ]}_{ξ}^{T} ‖ \qquad ( Fifty - Fifth Equation )$$

$$e = \{ {f}_{r} , {f}_{l} , {r}_{r} , {r}_{l} \} \qquad ( Fifty - Sixth Equation )$$

In this way, the image update unit F2 can apply the extended Kalman filter of the same model at the front distance by using the cross-range bearing for observation As described above, the number of observed edge bearings in image recognition is usually three, and at least one edge is missing. Therefore, the image update unit F2 removes the cross-range direction based on the missing edge bearing from the observation. That is, the state of the missing edge can be excluded from the target of this update.

Next, the size estimation method of the target object OBJ by the image update unit F2 will be described in detail. The image update unit F2 receives, as inputs, the tracker prediction value shown in a fifty-seventh expression, the error dispersion covariance matrix shown in a fifty-eighth expression, and the observation value of the edge bearing by the image shown in a fifty-ninth expression, and outputs the size estimation value of the target object OBJ shown in a sixtieth expression.

$${{ξ}^{...}}_{k + 1}^{n} \qquad ( Fifty - Seventh Equation )$$

$${M}_{k + 1}^{g , n} \qquad ( Fifty - Eighth Equation )$$

$${z}_{k}^{im , n} \qquad ( Fifty - Ninth Equation )$$

$$[ {ξ}_{k + 1 \vert k + 1}^{g , n} , {P}_{k + 1 \vert k + 1}^{g , n} ] \qquad ( Sixtieth Expression )$$

In the update of the geometric parameter using the Kalman filter, the observation of the edge e of the tracker prediction value is divided into the edges Efr, Efl, Err, and Erl, and set as the following sixty-first to sixty-fourth equations.

$${h}_{e}^{k} ( {\overline{ξ}}_{k + 1}^{n} ) = {regf}_{r} ( {\overline{ξ}}_{k + 1}^{n} ) \qquad ( Sixty - First Equation )$$

$${h}_{e}^{k} ( {\overline{ξ}}_{k + 1}^{n} ) = {regf}_{l} ( {\overline{ξ}}_{k + 1}^{n} ) \qquad ( Sixty - Second Equation )$$

$${h}_{e}^{k} ( {\overline{ξ}}_{k + 1}^{n} ) = {regr}_{r} ( {\overline{ξ}}_{k + 1}^{n} ) \qquad ( Sixty - Third Equation )$$

$${h}_{e}^{k} ( {\overline{ξ}}_{k + 1}^{n} ) = {regr}_{l} ( {\overline{ξ}}_{k + 1}^{n} ) \qquad ( Sixty - Fourth Equation )$$

Next, the parameter shown in a sixty-fifth expression is defined as the cross-range distance with respect to the observed edge e.

$${z}_{e}^{im} \qquad ( Sixty - Fifth Equation )$$

Here, the geometric parameter is expressed as a sixty-sixth equation. When the cross-range distance is observed as in a sixty-seventh equation, a negative log-likelihood function of the parameter shown in a sixty-eighth expression is expressed as the following sixty-ninth equation.

$${ξ}^{g} = {[ l , b ]}^{T} \qquad ( Sixty - Sixth Equation )$$

$${z}^{im} = \{ {z}_{e}^{im} \} \qquad ( Sixty - Seventh Equation )$$

$${ξ}^{g} \qquad ( Sixty - Eighth Equation )$$

$${L}_{{z}^{im}} ( {ξ}^{g} ) = - \frac{1}{2} {\sum }_{e} \frac{{\vert {v}_{e} \vert}^{2}}{{σ}_{im}^{2}} \qquad ( Sixty - Ninth Equation )$$

Note that it is assumed that a seventieth equation is established. In the sixty-ninth equation, a parameter shown by a seventieth equation is a cross-range distance observation error standard deviation.

$${v}_{e} = {z}_{e}^{im} - {h}_{e}^{k} ( {\overline{ξ}}_{k + 0}^{n} ) \qquad ( Seventieth Equation )$$

$${σ}_{im} \qquad ( Seventy - First Equation )$$

Here, regarding the sixty-ninth equation, when the seventy-second equation is established, the log-likelihood function takes the local maximum and the global maximum.

$${ξ}^{g} = {ξ}^{go} \qquad ( Seventy - Second Equation )$$

At this time, a Hessian matrix under the condition of a seventy-second equation is expressed as the following seventy-third equation. By using this Hessian matrix, it is possible to estimate the difficulty of estimating the geometric parameter.

$${H}_{ij}^{im} = \frac{{\partial }^{2} {L}_{{z}^{im}}}{\partial {ξ}_{i}^{k} \partial {ξ}_{j}^{k}} \qquad ( Seventy - Third Equation )$$

In one method of the Kalman filter, it is assumed that the prediction value shown in the seventy-fourth expression, the prediction error variance covariance matrix shown in the seventy-fifth equation, the observation matrix shown in the seventy-sixth expression, the observation error covariance matrix shown in the seventy-seventh expression, and an innovation shown in a seventy-eighth expression are given. In this case, the update amount as in the following seventy-ninth equation and the state estimation error covariance as in the following eightieth equation.

$$\text{?} \qquad ( Seventy - Fourth Equation )$$

$${M}^{g} \qquad ( Seventy - Fifth Equation )$$

$${H}^{g} \qquad ( Seventy - Sixth Equation )$$

$${R}^{g} \qquad ( Seventy - Seventh Equation )$$

$${v}^{g} \qquad ( Seventy - Eight Equation )$$

$$Δ {x}^{g} = {M}^{g} {{H}^{{g}^{T}} ( {H}^{g} {M}^{g} {H}^{{g}^{T}} + {R}^{g} )}^{- 1} {v}^{g} \qquad ( Seventy - Ninth Equation )$$

$${P}^{g} = {( {M}^{g - 1} + {H}^{{g}^{T}} {R}^{g - 1} + {H}^{g} )}^{- 1} \qquad ( Eightieth Equation )$$

In the calculation of the seventy-ninth and eightieth equations, when the size is estimated, the following eighty-first equation is established.

$${H}^{h} = {[ \frac{\partial {h}_{e}^{h}}{\partial {h}^{g}} ]}_{{ξ}_{k + 1}^{n}} \qquad ( Eighty - First Equation )$$

This calculation method does not reflect the difficulty of estimating the geometric parameter, and therefore may cause the convergence value to be incorrect. Therefore, the update amount and the state estimation error covariance may be calculated by changing the seventy-ninth equation as the following eighty-second equation.

$$( Eighty - Second Equation )$$

$$Δ {x}^{g} = {M}_{H}^{g} {{H}^{{g}^{T}} ( {H}^{g} {M}_{H}^{g} {H}^{{g}^{T}} + {R}^{g} )}^{- 1} {v}^{g}$$

However, it is assumed that the following eighty-third and eighty-fourth equations are established in the calculations of the eightieth and eighty-second equations. Note that η is an adjustment parameter.

$$( Eighty - Third Equation )$$

$${M}_{H}^{g} = {( {M}_{H}^{{g}^{- 1}} + η {H}^{i m} )}^{- 1}$$

$$( Eighty - Fourth Equation )$$

$${R}_{H}^{g} = η {H}^{g} {H}^{i m} {H}^{{g}^{T}}$$

In the calculations of the eighty-second and eighty-third equations, it is necessary to calculate the point where the likelihood function is maximized and calculate the Hessian matrix before calculating the update amount. When the processor 11 executes both calculations each time, the amount of calculation processing required for both calculations becomes enormous. Therefore, there are concerns that the performance of the high-performance processor 11 is required and that the tracking process is delayed.

Therefore, the tracking device 10 of the present embodiment includes a lookup table T1. The lookup table T1 is a table that stores the correspondence relation between the relative direction of the target object OBJ calculated in advance outside the tracking device 10 and the Hessian matrix. The lookup table T1 may be implemented in the form of data stored in the memory 12, or may be implemented in the form of a non-transitory tangible storage medium such as a dedicated semiconductor memory and the like separate from the memory 12.

The image update unit F2 refers to the lookup table T1, and obtains the corresponding Hessian matrix based on the relative direction of the target object OBJ. As can be seen from the seventy-third equation, the difficulty of estimating the geometric parameter is strongly correlated with the relative direction of the target object OBJ with respect to the subject vehicle EV. Therefore, the correspondence relation between the relative direction of the target object OBJ and the Hessian matrix is calculated in advance and implemented. Thereby, it may be possible to prevent the increase in the amount of calculation processing in the update amounts of the eighty-second and eighty-third equations and the state estimation error covariance.

The image update unit F2 can finally calculate the size estimation value by the following eighty-fifth equation.

$$( Eighty - Fifth Equation )$$

$$[ {ξ}_{k + 1 \vert k + 1}^{g , n} , {P}_{k + 1 \vert k + 1}^{g , n} ] = [ {\overline{ξ}}_{k + 1}^{g , n} + Δ {x}^{g} , {M}_{H}^{g} ]$$

In S106 after the process of S105, the image update unit F2 updates the state by the likelihood. Specifically, the image update unit F2 receives, as the inputs, the prediction value of the motion parameter shown in an eighty-sixth expression, the size estimation value shown in an eighty-seventh expression, and the observation value of the edge bearing shown in an eighty-eighth expression, and outputs the updated motion parameter by the image shown in an eighty-ninth expression. The prediction value of the motion parameter is predicted by the state prediction unit F1. The size estimation value is estimated in S104.

$$( Eighty - Sixth Expression )$$

$$[ {\overline{ξ}}_{k + 1}^{k , n} , {M}_{k + 1}^{k , n} ]$$

$$( Eighty - Seventh Expression )$$

$${ξ}_{k + 1 \vert k + 1}^{g , n}$$

$$( Eighty - Eighth Expression )$$

$${z}_{k}^{im , n}$$

$$( Eighty - Ninth Expression )$$

$$[ {ξ}_{k + 1 \vert k + 1}^{k , im , n} , {P}_{k + 1 \vert k + 1}^{k , im , n} ]$$

Hereinafter, each parameter shown in a ninetieth expression is rewritten as a ninety-first expression, and the description will continue.

$$( Ninetieth Equation )$$

$${\overline{ξ}}_{k + 1}^{k , n} , {M}_{k + 1}^{k , n} , {ξ}_{k + 1 \vert k + 1}^{g , n} , {z}_{k}^{i m , n} , {ζ}_{k + 1 \vert k + 1}^{k , im , n} , {P}_{k + 1 \vert k + 1}^{k , im , n}$$

$$( Ninety - First Equation )$$

$${\overline{ξ}}_{k + 1}^{k} , {M}_{k + 1}^{k} , {ξ}_{k + 1 \vert k + 1}^{g} , {z}_{k}^{i m} , {ξ}_{k + 1 \vert k + 1}^{k ,} , {P}_{k + 1 \vert k + 1}^{k , im}$$

The image update unit F2 calculates the average estimation value of the motion parameter based on a ninety-second equation and the error covariance matrix of the motion parameter based on the ninety-third equation by the Kalman filter using the cross-range bearing as the observation amount.

$$( Ninety - Second Equation )$$

$${ξ}_{k + 1 \vert k + 1}^{k , im} = {\overline{ξ}}_{k + 1}^{k} + {K}_{k + 1}^{i m} ( \sqrt{{x}_{{\overline{ξ}}_{k + 1}^{k}}^{2} + {y}_{{\overline{ξ}}_{k + 1}^{k}}^{2}} {z}_{k}^{i m} - {h}^{i m} ( {[ {( {\overline{ξ}}_{k + 1}^{k} )}^{T} {( {ξ}_{k + 1 \vert k + 1}^{g} )}^{T} ]}^{T} , 0 ) )$$

$$( Ninety - Third Equation )$$

$${P}_{k + 1 \vert k + 1}^{k , im} = {M}_{k + 1}^{k} - {K}_{k + 1}^{i m} {H}_{k + 1}^{i m} {M}_{k + 1}^{k}$$

However, each function or parameter used in the ninety-second and ninety-third equations is indicated by the ninety-fourth and ninety-fifth equations.

$$( Ninety - Fourth Equation )$$

$${H}_{k + 1}^{i m} = \frac{\partial {h}^{i m} ( ξ , {w}_{k} )}{\partial {ξ}^{k}} {\vert}_{ξ = {[ {( {\overline{ξ}}_{k + 1}^{k} )}^{T} {( {ξ}_{k + 1 \vert k + 1}^{g} )}^{T} ]}^{T} , {w}_{k} = 0}$$

$$( Ninety - Fifth Equation )$$

$${K}_{k + 1}^{i m} = {M}_{k + 1}^{k} {{H}_{k + 1}^{im} ( {H}_{k + 1}^{i m} {{M}_{k + 1}^{k} ( {H}_{k + 1}^{i m} )}^{T} + {R}^{i m} )}^{- 1}$$

As described above, the calculation for the update by the image update unit F2 is completed. In S107 after the process of S106, the image update unit F2 outputs the target object state updated by the image, that is, the tracker set updated by the image, and provides it to the radar update unit F3.

The radar update unit F3 further updates the target object state updated by the image based on the likelihood of the point cloud of the observation point by the millimeter wave radar 30, and obtains the estimation result of the final target object state at the second time.

Specifically, the radar update unit F3 executes a process based on a process method shown in a flowchart of FIG. 8. Hereinafter, details will be described according to S201 to S204 of the flowchart.

In the first S201, the radar update unit F3 acquires the updated tracker set based on the image, as shown in a ninety-sixth equation.

$$( Ninety - Sixth Equation )$$

$${Ξ}_{k + 1 \vert k + 1}^{i m} = \{ [ [ {ξ}_{k + 1 \vert k + 1}^{i m ,} , {P}_{k + 1 \vert k + 1}^{im , 1} ] , [ {ξ}_{k + 1 \vert k + 1}^{im , 2} , {P}_{k + 1 \vert k + 1}^{im , 2} ] , … , [ {ζ}_{k + 1 \vert k + 1}^{im , {N}_{k}} , {P}_{k + 1 \vert k + 1}^{im , {N}_{k}} ] ] \}$$

S202 may be executed after the process of S201, simultaneously with S201, or before the process of S201. In S202, the radar update unit F3 acquires the latest point cloud data observed by the millimeter wave radar 30. The point cloud is expressed as the following ninety-seventh equation. However, the parameter of each observation point in the ninety-seventh equation is expressed as the following ninety-eighth equation.

$$( Ninety - Seventh Equation )$$

$${Z}_{k + 1}^{m m r} = \{ {z}_{k + 1}^{mmr , 1} , {z}_{k + 1}^{mmr , 2} , … , {z}_{k + 1}^{mmr , {L}_{k + 1}} \}$$

$$( Ninety - Eighth Equation )$$

$${z}_{k}^{mmr , j} = {[ {R}^{j} , {u}^{j} , {\dot{R}}^{j} ]}^{T}$$

In the matrix in the ninety-eighth equation, parameters from left to right are a distance [m], a bearing, and a relative velocity [m/s]. The bearing here is expressed by the following ninety-ninth equation when θ is an angle [rad] indicating the bearing of the observation point.

$$( Ninety - Ninth Equation )$$

$$u = sin ( θ )$$

In S203 after the processes of S201 and S202, the radar update unit F3 associates the tracker set with the point cloud. The radar update unit F3 allocates one or more observation points to each tracker in the association.

When multiple target object OBJs are recognized, this allocation may be an exclusive allocation among the target object OBJs. On the other hand, in the exclusive allocation, the number of combinations tends to be very high, and the calculation process amount may increase.

Therefore, in the process of S203, the radar update unit F3 may allow the overlapping of allocations and the erroneous association by the clutter, and may address it in the process of S204. For example, the radar update unit F3 allocates a subset of the point cloud for each tracker. Specifically, the radar update unit F3 defines a validation region centered on the target object OBJ. Then, the radar update unit F3 allocates the observation point existing inside the validation region to each tracker.

The validation region may be, for example, an elliptical region. The validation region may be defined as an ellipse whose center is the target object center and whose major-axis length and minor-axis length are set to predetermined multiples of the target OBJ's major-axis dimension I and minor-axis dimension b, respectively.

The subset of the point cloud allocated to the p-th tracker is expressed by the following hundredth equation. Here, #p represents the total number of observation points.

$$( Hundredth Equation )$$

$${Z}_{k + 1}^{mmr , p} = \{ {z}_{k + 1}^{p , 1} , {z}_{k + 1}^{p , 2} , … , {z}_{k + 1}^{p , \# p} \}$$

In S204 after the process of S203, the radar update unit F3 updates the target object state based on the likelihood of the point cloud. Specifically, the updated tracker set based on the image acquired in S201 is updated. In this update, a multiple algebraic hypothesis method is used. That is, since it is extremely difficult to identify from which part of the target object OBJ each observation point observed by the millimeter wave radar 30 is reflected, each observation point is treated independently by algebraically assigning, to each observation point, a correspondence with a reflection source (this is referred to as an “independent hypothesis”). Since it is difficult to definitively specify the correspondence between the observation point and the reflection source, multiple correspondence hypotheses are set.

Specifically, it is assumed that ξ is the state of the target object OBJ, the function shown in a one hundred first expression is the prediction distribution of the target object OBJ, and the set shown in a one hundred second equation is a plurality of observation points assigned to the target object OBJ.

$$( One Hundred First Expression )$$

$$( p ) ξ$$

$$( One Hundred Second Expression )$$

$$\{ z \} = \{ {z}^{1} , {z}^{2} , … , {z}^{M} \}$$

Furthermore, the likelihoods (hereinafter, multiple observation likelihoods) of the multiple observation points are expressed as a one hundred third expression, and it is assumed that a one hundred fourth equation is established based on the independent hypothesis.

$$\qquad ( One Hundred Third Expression )$$

$$p ( \{ z \} \vert ξ )$$

$$( One Hundred Fourth Equation )$$

$$p ( \{ z \} \vert ξ ) = \prod p ( {z}^{m} \vert ξ )$$

At this time, the radar update unit F3 can calculate the posterior distribution of the target object OBJ based on a one hundred fifth equation. The radar update unit F3 can sequentially update each observation point.

$$( One Hundred Fifth Equation )$$

$$p ( ξ \vert \{ z \} ) ∝ p ( ξ \vert \{ z \} ) p ( ξ ) = p ( ξ ) \prod p ( {z}^{m} \vert ξ )$$

However, the parameter used in the one hundred fifth equation and shown in a one hundred sixth expression is the likelihood (hereinafter referred to as a single observation likelihood) of one observation point.

$$( One Hundred Sixth Expression )$$

$$p ( {z}^{m} \vert ξ )$$

Here, the details of the single observation likelihood will be described. The single observation likelihood can be expressed as a one hundred seventh equation based on the multiple algebraic hypothesis. The j indicates the hypothesis adopted for the observation point.

$$\begin{matrix} & ( One Hundred Seventh Expression )\end{matrix}$$

$$p ( {z}^{m} \vert ξ ) = {\sum }_{j} p ( {τ}^{j} \vert ξ ) p ( {z}^{m} \vert ξ , {τ}^{j} )$$

Here, the parameter used in the one hundred seventh equation and shown in a one hundred eighth expression is the occurrence rate of the correspondence represented by a one hundred ninth expression.

$$( One Hundred Eighth Expression )$$

$$p ( {τ}^{j} \vert ξ )$$

$$( One Hundred Ninth Expression )$$

$${τ}^{j}$$

Furthermore, a parameter used in the one hundred seventh equation and shown in a one hundred tenth expression is the likelihood when the correspondence of the one hundred ninth expression is given to the observation point of a one hundred eleventh equation.

$$( One Hundred Tenth Expression )$$

$$p ( {z}^{m} \vert ξ , {τ}^{i} )$$

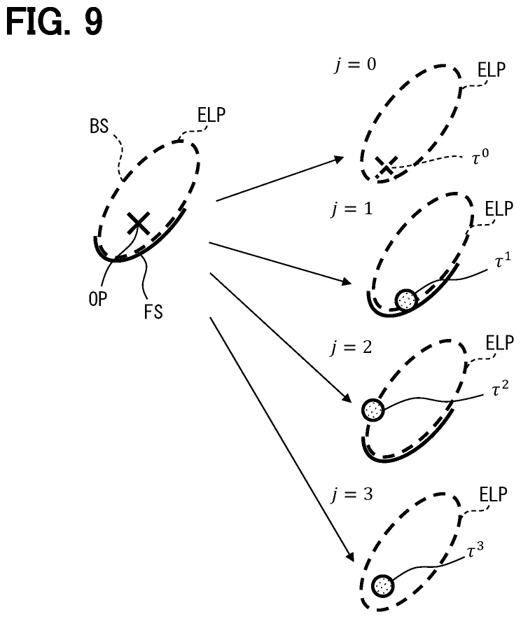

Here, as shown in FIG. 9, four correspondence hypotheses are considered as a generation hypothesis of one observation point. The four hypotheses are a clutter hypothesis (j=0), an on-perimeter forward hypothesis (j=1), an on-perimeter reverse hypothesis (j=2), and an interior hypothesis (j=3). The clutter hypothesis is a hypothesis that a target observation point OP does not observe the reflected wave from the target object OBJ, but is a clutter.

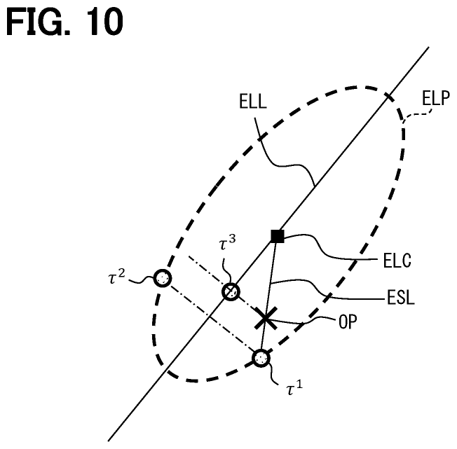

The on-perimeter forward hypothesis, the on-perimeter reverse hypothesis, and the interior hypothesis are hypotheses that the target observation point OP represents a reflected wave from the target object OBJ. As a premise for describing these hypotheses in detail, it is assumed that the shape of the target object OBJ is elliptical, as shown in FIG. 10. This ellipse is called a hypothesized ellipse ELP.

The on-perimeter forward hypothesis and the on-perimeter reverse hypothesis are hypotheses that the target observation point OP represents a reflected wave from an outer peripheral portion of the object OBJ. Specifically, as shown in FIG. 10, the on-perimeter forward hypothesis is a hypothesis that a reflected wave is observed from an intersection point between (i) a straight line connecting a center position ELC of the hypothesized ellipse ELP and the observation point OP and (ii) the perimeter of the hypothesized ellipse ELP. The on-perimeter reverse hypothesis is a hypothesis that a reflected wave is observed from a position that is line-symmetric to the intersection point with respect to a major axis ELL of the hypothesized ellipse ELP.

The interior hypothesis is a hypothesis that the target observation point OP represents a reflected wave from inside the target object OBJ. The reflection position may be, for example, a position obtained by projecting the observation point OP onto the major axis ELL of the hypothesized ellipse ELP.

The occurrence rate of the clutter hypothesis is expressed by the following one hundred eleventh equation.

$$( One Hundred Eleventh Equation )$$

$$p ( {τ}^{0} \vert ξ ) = {α}_{c}$$

Also, the total occurrence rate of the on-perimeter forward hypothesis, the on-perimeter reverse hypothesis, and the interior hypothesis is expressed by the following one hundred twelfth equation.

$$( One Hundred Twelfth Equation )$$

$${α}_{t} = 1 - {α}_{c}$$

When the on-perimeter forward hypothesis and the on-perimeter reverse hypothesis are adopted, the reflection point corresponding to an observation point is classified into a case where it lies on the side facing the subject vehicle EV (hereinafter denoted as “face” in the following equations) and a case where it lies on the opposite side, i.e., the side facing away from the subject vehicle EV (hereinafter denoted as “back”). Here, when the occurrence rate of the on-perimeter forward hypothesis and the on-perimeter reverse hypothesis is expressed by a one hundred thirteenth expression, the occurrence rate of the on-perimeter forward hypothesis is expressed by a one hundred fourteenth equation, and the occurrence rate of the on-perimeter reverse hypothesis is expressed by a one hundred fifteenth equation.

$$( One Hundred Thirteenth Expression )$$

$${α}_{e}$$

$$( One Hundred Fourteenth Equation )$$

$$p ( {τ}^{1} \vert ξ ) = \{ \begin{matrix}{α}_{t} \cdot {α}_{e} \cdot p ( face ) , if {τ}^{1} ∈ face \\ {α}_{t} \cdot {α}_{e} \cdot p ( back ) , otherwise\end{matrix}$$

$$( One Hundred Fifteenth Equation )$$

$$p ( {τ}^{2} \vert ξ ) = \{ \begin{matrix}{α}_{t} \cdot {α}_{e} \cdot p ( face ) , if {τ}^{1} ∈ face \\ {α}_{t} \cdot {α}_{e} \cdot p ( back ) , otherwise\end{matrix}$$

Further, when the following one hundred sixteenth equation is satisfied, the occurrence rate of the interior hypothesis is expressed as the following one hundred seventeenth equation.

$$( One Hundred Sixteenth Equation )$$

$${α}_{i n} ( = 1 - {α}_{e} )$$

$$( One Hundred Seventeenth Equation )$$

$$p ( {τ}^{3} \vert ξ ) = \{ \begin{matrix}{α}_{t} \cdot {α}_{in} , if z ∈ ellipse \\ 0 , otherwise\end{matrix}$$

The case classification in a one hundred seventeenth equation is performed based on whether the observation point exists inside the hypothesized ellipse. When the observation point exists outside the hypothesized ellipse, the occurrence rate is 0.

By way of example, as shown in FIG. 9, when the observation point is located inside the hypothesized ellipse, the reflection position is on the facing side in a case where the on-perimeter forward hypothesis is adopted. Further, the reflection position is on the back side in a case where the on-perimeter reverse hypothesis is adopted. In these cases, the single observation likelihood is as shown in a one hundred eighteenth equation.

$$\qquad ( One Hundred Eighteenth Equation )$$

$$p ( z \vert ξ ) ∝ {\sum }_{j = 0}^{3} p ( z \vert {τ}^{j} , ξ ) p ( {τ}^{j} \vert ζ ) = p ( z \vert {τ}^{0} , ξ ) {α}_{c} + p ( z \vert {τ}^{1} , ξ ) {α}_{c} + p ( z \vert {τ}^{1} , ξ ) {α}_{t} \cdot {α}_{e} p ( face ) + p ( z \vert {τ}^{2} , ξ ) {α}_{t} {α}_{e} p ( back ) + p ( z \vert {τ}^{3} , ξ ) {α}_{t} {α}_{i n}$$

The likelihood in the correspondence of the clutter hypothesis (i.e., the likelihood in the case of j=0) may be uniformly distributed as in a one hundred nineteenth equation. The V in the one hundred thirteenth expression is the area of the validation region described above.

$$( One Hundred Nineteenth Equation )$$

$$p ( z \vert {τ}^{0} , ξ ) = \frac{1}{V}$$

The likelihood for the correspondences of the other hypotheses, i.e., the on-perimeter forward hypothesis, the on-perimeter reverse hypothesis, and the interior hypothesis (that is, the likelihood in the cases of j=1, 2, and 3), is set to be a Gaussian distribution, as expressed in a one hundred twentieth equation below.

$$( One Hundred Twentieth Equation )$$

$$p ( z \vert {τ}^{j} , ξ ) = N ( h ( {τ}^{j} , ξ ) , R )$$

Here, the parameter used in the one hundred twentieth equation and shown in a one hundred twenty-first equation is the observation value of § at the correspondence point T, and R is the variance covariance matrix of the observation noise.

$$( One Hundred Twenty - First Equation )$$

$$h ( τ , ξ )$$

Furthermore, a hypothesis weight shown in a one hundred twenty-second equation is introduced. Using the hypothesis weight, the one hundred seventh equation is expressed as a one hundred twenty-third equation.

$$( One Hundred Twenty - Second Equation )$$

$${w}^{j} = p ( {τ}^{j} \vert ξ ) / \sum p ( {τ}^{j} \vert ξ )$$

$$( One Hundred Twenty - Third Equation )$$

$$p ( z \vert ξ ) = \sum {w}^{j} p ( z \vert {τ}^{j} , ξ )$$

As the expression of the posterior distribution shown by the one hundred fifth equation, a Gaussian Mixture Model (GMM) is introduced, and a one hundred twenty-fourth equation and a one hundred twenty-fifth equation are established. The GMM represents a data set by overlapping multiple Gaussian distributions. Thereby, the radar update unit F3 can process each observation point in order and sequentially update it.

$$( One Hundred Twenty - Fourth Equation )$$

$$p ( ξ ) = \sum {λ}^{i} N ( {\overline{ξ}}^{i} , {M}^{i} )$$

$$( One Hundred Twenty - Fifth Equation )$$

$$\sum {λ}^{i} = 1$$

Specifically, the posterior distribution is expressed as a one hundred twenty-sixth equation based on the one hundred fifth equation, the one hundred nineteenth equation, the one hundred twentieth equation, the one hundred twenty-third equation, and the like.

$$( One Hundred Twenty - Sixth Equation )$$

$$p ( ξ \vert \{ z \} ) ∝ p ( ξ ) ( \frac{{w}^{0}}{V} + {\sum }_{j = 1} {w}^{j} N ( {z}^{1} \vert h ( {τ}^{j} , ξ ) , R ) ) {\prod }_{m = 2} p ( {z}^{m} \vert ξ )$$

Here, the

$$p ( ξ ) ( \frac{{w}^{o}}{V} + {\sum }_{j = 1} {w}^{j} N ( {z}^{1} \vert h ( {τ}^{j} , ξ ) , R ) )$$

of the one hundred twenty-sixth equation can be deformed as follows.

$$( One Hundred Twenty - Seventh Equation )$$

$$\begin{matrix}p ( ξ ) ( \frac{{w}^{0}}{V} + {\sum }_{j} {w}^{j} N ( {z}^{1} \vert h ( {τ}^{j} , ξ ) , R ) ) \\ = ( \sum {λ}^{i} N ( ξ \vert {\overline{ξ}}^{i} , {M}^{i} ) ) ( {w}^{0} / V + \sum {w}^{j} N ( {z}^{1} \vert h ( {τ}^{j} , ξ ) , R ) ) \\ = \frac{{w}^{0}}{V} {\sum }_{i} {λ}^{i} N ( ξ \vert {\overline{ξ}}^{i} , {M}^{i} ) + {\sum }_{i} {\sum }_{j = 1} {λ}^{i} {w}^{j} N ( {z}^{1} \vert h ( {τ}^{j} , ξ ) , R ) N ( ξ \vert {\overline{ξ}}^{i} , {M}^{i} )\end{matrix}$$

Since the N(z¹|h(τ^{j},ξ),R)N(ξ|ξ̅ⁱ, Mⁱ) of the one hundred twenty-seventh equation is the product of the likelihood that is the Gaussian distribution and the posterior distribution that is the Gaussian distribution, it can be understood that the extended Kalman filter can be applied. On the premise that two parameters shown in a one hundred twenty-eighth expression depend on parameters shown in a one hundred twenty-ninth expression, and therefore are rewritten as a one hundred thirtieth expression.

$${τ}^{j} , {w}^{j} \qquad ( One Hundred Twenty - Eighth Expression )$$

$${\overline{ξ}}^{i} \qquad ( One Hundred Twenty - Ninth Expression )$$

$${τ}_{i}^{j} , {w}_{i}^{j} \qquad ( One Hundred Thirtieth Expression )$$

In order to apply the extended Kalman filter to the N(z¹|h(τ^{j},ξ),R)N(ξ|ξ̅ⁱ,Mⁱ) of the hundred twenty-seventh equation, one hundred thirty-first equation to one hundred thirty-seventh equations are applied.

The

$$p ( ξ ) ( \frac{{w}^{o}}{V} + {\sum }_{j = 1} {w}^{j} N ( {z}^{1} \vert h ( {τ}^{j} , ξ ) , R ) )$$

of the one hundred twenty-sixth equation can be expressed as the one hundred twenty-seventh equation.

$${v}^{i , j} = {z}^{1} - h ( {τ}_{i}^{j} , {\overline{ξ}}^{i} ) \qquad ( One Hundred Thirty - First Equation )$$

$${S}^{i , j} = R + {H}^{i , j} {M}^{i} {H}^{i , {j}^{T}} \qquad ( One Hundred Thirty - Second Equation )$$

$${H}^{i , j} = \frac{\partial h}{\partial ξ} {\vert}_{{τ}_{i}^{j} , {\overline{ξ}}^{i}} \qquad ( One Hundred Thirty - Third Equation )$$

$${K}^{i , j} = {M}^{i} {H}^{i , {j}^{T}} {S}^{i , {j}^{- 1}} \qquad ( One Hundred Thirty - Fourth Equation )$$

$$( One Hundred Thirty - Fifth Equation )$$

$${β}^{i , j} = \frac{1}{{( 2 π )}^{\frac{3}{2}} {\vert {S}^{i , j} \vert}^{\frac{1}{2}}} exp ( - \frac{1}{2} {v}^{i , {j}^{T}} {S}^{i , {j}^{- 1}} {v}^{i , j} )$$

$${\overline{ξ}}^{i , j} = {\overline{ξ}}^{i} + {K}^{i , j} {v}^{i , j} \qquad ( One Hundred Thirty - Sixth Equation )$$

$${M}^{i , j} = {M}^{i} - {K}^{i , j} {S}^{i , j} {H}^{i , {j}^{T}} \qquad ( One Hundred Thirty - Seventh Equation )$$

$$( One Hundred Thirty - Eighth Expression )$$

$$p ( ξ ) ( \frac{{w}^{0}}{V} + {\sum }_{j} {w}^{j} N ( {z}^{1} \vert h ( {τ}^{j} , ξ ) , R ) ) ≃ \frac{{w}^{0}}{V} {\sum }_{i} {λ}^{i} N ( ξ \vert {\overline{ξ}}^{i} , {M}^{i} ) + {\sum }_{i} {\sum }_{j} {λ}^{j} {w}_{j}^{i} {β}^{i , j} N ( {\overline{ξ}}^{i , j} , {M}^{i , j} )$$

Since a one hundred thirty-eighth expression is the GMM, the radar update unit F3 can update the first observation point as described in the following one hundred thirty-ninth expression, for example, by setting the sum of weights to 1 or the merge process and the like. The radar update unit F3 sequentially updates by the first observation point and the second and subsequent observation points, and obtains the final desired posterior distribution.

$$p ( ξ \vert {z}^{1} ) ≃ {\sum }_{i} {λ}^{1 , i} N ( {\overline{ξ}}^{1 , i} , {M}^{1 , i} ) \qquad ( One Hundred Thirty - Ninth Expression )$$

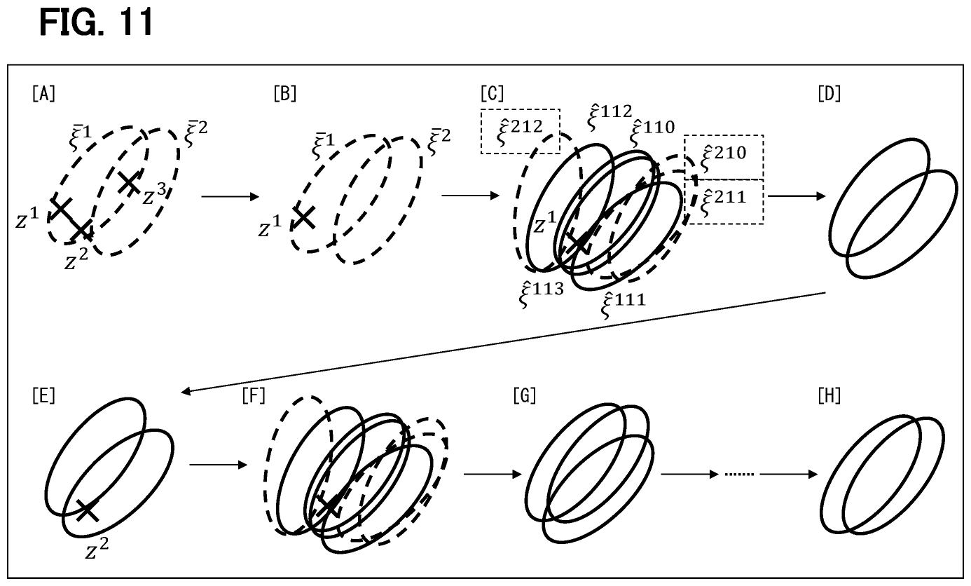

For ease of understanding, with reference to FIG. 11, an update procedure for obtaining the posterior distribution from the prior distribution by the point cloud of the millimeter wave radar 30 will be described. The procedure described here may also be referred to as a process.

In a procedure [A], the radar update unit F3 grasps the state of the target object OBJ in the prior distribution and the observation point by the millimeter wave radar 30. For example, for the purpose of explanation, it is assumed that the number of states (in other words, the number of GCs) is two and the number of observation points is three. In the actual process, it is assumed that the number of GCs and the number of observation points are higher. The GC is a Gaussian Component and means the individual Gaussian distributions that constitute the Gaussian mixed model. The GC can be characterized by an average value indicating the center of the Gaussian distribution, a covariance indicating the spread of the distribution, and a mixed weight contributing to the Gaussian mixed model.

The radar update unit F3 starts updating by the first observation point (in a procedure [B]). The update by the first observation point continues until the procedure [D]. Specifically, the radar update unit F3 executes the update process for each GC and correspondence hypothesis. That is, the radar update unit F3 executes the application process of the extended Kalman filter a number of times (for example, six times) that is the product of the number of GCs and the number of observation points.

In the procedure [C], the update state based on each hypothesis is grasped by applying the extended Kalman filter. The four ellipses shown by solid lines in FIG. 11 correspond to four hypotheses assumed for the first GC. In FIG. 11, in the superscript of ξ, the first character indicates the first Gaussian component (GC), the second character indicates the first observation point, and the third character indicates the index corresponding to the hypothesis (j=0, 1, 2, 3).

Three ellipses shown by broken lines in FIG. 11 correspond to three hypotheses assumed for the second GC. As shown in the procedures [A] and [B], the first observation point is located outside the second GC before the update. Therefore, in the second GC, the internal hypothesis is excluded from the assumption, and three hypotheses of the clutter hypothesis, the on-perimeter forward hypothesis, and the on-perimeter reverse hypothesis are assumed.

In the procedure [D], the radar update unit F3 performs merging of similar hypotheses and marginal-likelihood-based pruning to narrow down the hypotheses to be adopted from among multiple hypotheses. In the example of FIG. 11, each of the two GCs were narrowed down to one hypothesis. Thereby, the update by the first observation point ends. That is, the distribution is updated as in the following fortieth equation.

$$p ( ξ ) = \sum {λ}^{1 , i} N ( {\hat{ξ}}^{1 , i} , {M}^{1 , i} ) \qquad ( One Hundred Fortieth Equation )$$

Here, the merging process of similar hypotheses is a process of integrating multiple hypotheses having similar average values to obtain one state. Here, the state that the average value is close means that the difference between the average values in the multiple hypotheses is within a preset integration target range.

Pruning based on the marginal likelihood is a process of excluding hypotheses with small hypothesis weights from the candidates. The candidates to be excluded may be determined on an absolute basis or on a relative basis. In the case of absolute criteria, the candidate to be excluded may be a candidate whose hypothesis weight falls below a preset absolute threshold. In the case of relative criteria, the candidate to be excluded may be a candidate whose hypothesis weight difference from the candidate with the highest hypothesis weight is greater than a preset threshold.

In procedures [E], [F], and [G], the radar update unit F3 executes the similar process to the first observation point for the second observation point. As in the procedure [G], the similar hypothesis merging process and the pruning process based on the marginal likelihood may not narrow down the hypothesis to one. Therefore, the number of updated GCs is increasing. The distribution is updated as shown in the following one hundred forty-first equation.

$$p ( ξ ) = \sum {λ}^{2 , i} N ( {\hat{ξ}}^{2 , i} , {M}^{2 , i} ) \qquad ( One Hundred Forty - First Equation )$$

Thereafter, the radar update unit F3 executes the similar process to the first and second observation points for the third observation point. As the result, the distribution is updated as shown in the following one hundred forty-second equation (see also a procedure [H]). When all observation points are updated, the final posterior distribution is determined. By executing this for all target objects that are being tracked, the radar update unit F3 can output the tracker set indicating the estimation value of the target object state at the second time (time k+1).

$$p ( ξ ) = \sum {λ}^{3 , i} N ( {\hat{ξ}}^{3 , i} , {M}^{3 , i} ) \qquad ( One Hundred Forty - Second Equation )$$

The radar update unit F3 may set an upper limit number of the number of GCs used at the time of update. Therefore, thresholds of the hypothesis merging process and the narrowing down by the pruning process based on the marginal likelihood may be adjusted so as to more exclude the hypothesis candidate.

As described above, in the tracking device 10, the likelihood for fusing the image data observed by the image sensor 20 and the point cloud data observed by the millimeter wave radar 30 is designed as the product of the likelihood based on the image recognition result and the likelihood based on the point cloud of the observation point.

The target object state estimated by the tracking device 10 may be provided to a driving assistance device that assists driving of the driver and may be used for driving assistance. The driving assistance device may control the speed of the subject vehicle EV so as to maintain the vehicle-to-vehicle distance between the subject vehicle EV and the preceding vehicle based on the target object state of the preceding vehicle, for example, to implement the function of ACC (Adaptive Cruise Control).

The target object state estimated by the tracking device 10 may be provided to the automated driving device that implements the automated driving of the subject vehicle EV, and may be used for the automated driving. The automated driving device may plan the behavior of the subject vehicle EV using the target object state of the tracked target object, and control the subject vehicle based on the behavior.

The target object state estimated by the tracking device 10 may be provided to the information presentation device of the subject vehicle EV, and may be used to present target object information to the driver. The information presentation device may be a display device such as a meter display, or may be a voice presentation device such as a speaker.

According to the first embodiment described above, the likelihood for fusing the image and the point cloud can be designed as a product of the likelihood based on the recognition result of the image and the likelihood based on the point cloud of the observation point. Therefore, the target object state can be obtained rationally from different types of sensors. Then, the prediction target object state is updated first based on the recognition result of the image by the image sensor 20 among the image by the image sensor 20 and the point cloud of the observation point of the millimeter wave radar 30. Since the image recognition result has less noise such as clutter than the point cloud of the observation point of the millimeter wave radar 30, it is easy to specify the association between the prediction target object state and the target object to be tracked. Then, after the association is clarified using the image, the point cloud of the observation point of the millimeter wave radar 30 is updated. Therefore, it is possible to implement robust tracking.

Further, according to the first embodiment, in the update by the likelihood based on the image recognition result, the Kalman filter is applied by modeling the likelihood function using the edge bearing of the target object OBJ in the image recognition result. In modeling the likelihood function, the edge bearing is used in a state where the distance to the target object OBJ is normalized. The error and the standard deviation of the edge bearing are normalized by the distance. Thereby, it may be possible to reduce the dependence on the distance true value. Therefore, it may be possible to prevent the use of the Kalman filter of the different model for each distance, and make the model common.

Further, according to the first embodiment, the target object state includes the geometric parameter of the target object OBJ and the motion parameter of the target object OBJ. The geometric parameters are updated through the update using the likelihood based on the image recognition results, among the update using the likelihood based on the image recognition results and the update using the likelihood based on the point cloud. The point cloud of the millimeter wave radar 30 is difficult to contribute to the size of the target object OBJ since the position is uncertain. Therefore, by updating the geometric parameters with the image, it is possible to implement robust tracking while reducing the amount of calculation processing in updating by the likelihood based on the point cloud.

Further, according to the first embodiment, in the update by the likelihood based on the point cloud, an outline model representing the outline shape of the target object for defining the correspondence with the observation point of the reflection source is set. Then, multiple correspondence hypotheses that are hypotheses according to multiple types of correspondence are set, and the image update target object state is further updated based on the multiple correspondence hypotheses. Here, the outline model is set in an elliptical shape. In the outline model set in the elliptical shape, the outer shape can be expressed by one relatively simple mathematical expression. Therefore, it may be possible to reduce the amount of calculation processing.

Further, according to the first embodiment, in updating the second likelihood based on the point cloud, it is determined whether the observation point is based on reflection from the facing side of the target object OBJ or an observation point is based on reflection from the back side of the target object OBJ. Then, a different distribution is given to the target object state depending on whether it is based on the facing side or the back side. It is possible to improve the accuracy of the distribution for representing the target object state, and implement more robust tracking.

### Second Embodiment

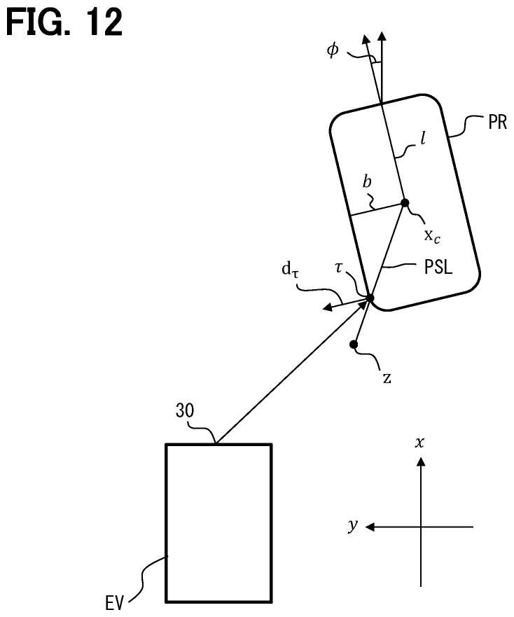

As shown in FIG. 12, a second embodiment is a modification of the first embodiment. The description of the second embodiment will focus on the differences from the first embodiment.

In the first embodiment, in the update by the millimeter wave radar 30, the outline shape of the target object OBJ is assumed to be the hypothesized ellipse ELP.

On the other hand, in the subject vehicle EV, the main target object to be recognized is a different vehicle (four-wheeled vehicle). In the second embodiment, the outer shape of the target object OBJ is assumed to be a pseudo-rectangle PR that is a pseudo-rectangular shape closer to the shape of the different vehicle. The n-th order pseudo-rectangle is defined by the following one hundred forty-third equation. The pseudo-rectangle may be a rectangle in which four edge portions are represented by a continuous curve in order to represent the shape by one mathematical expression. The order n is a natural and even number. The smaller the order n, the closer it becomes to the ellipse, and the larger the order n, the closer it becomes to the rectangle.

$${‖ {Δ}^{- 1} {R}_{ϕ}^{T} ( τ - {x}_{c} ) ‖}_{n}^{n} = 1 \qquad ( One Hundred Forty - Third Equation )$$

Here, regarding the one hundred forty-third equation, it is assumed that the following one hundred forty-fourth to one hundred forty-sixth equations are established. Note that I shown in the one hundred forty-fifth equation is the radius in the major-axis direction of the pseudo-rectangle PR, and b is the radius in the minor-axis direction. Similarly to FIG. 3, the q shown in the one hundred forty-sixth equation is an angle representing the direction of the target object OBJ with respect to the x-axis.

$${‖ x ‖}_{n} = {( {x}_{1}^{n} + {x}_{2}^{n} )}^{\frac{1}{n}} \qquad ( One Hundred Forty - Fourth Equation )$$

$$Δ = [ \begin{matrix}l & 0 \\ 0 & b\end{matrix} ] \qquad ( One Hundred Forty - Fifth Equation )$$

$${R}_{ϕ} = [ \begin{matrix}cos ϕ & - sin ϕ \\ sin ϕ & cos ϕ\end{matrix} ] \qquad ( One Hundred Forty - Sixth Equation )$$

The parameter used in the one hundred forty-third equation and shown in a one hundred forty-seventh expression is the center position of the pseudo-rectangle PR.

$${x}_{c} \qquad ( One Hundred Forty - Seventh Equation )$$

The T is the intersection point between a straight line PSL connecting the center position of the pseudo-rectangle PR and an observation point z and the outer peripheral portion of the pseudo-rectangle PR. The straight line PSL can be expressed as the following one hundred forty-eighth equation.

$$τ = k ( z - {x}_{c} ) + {x}_{c} \qquad ( One Hundred Forty - Eighth Equation )$$

Substituting the one hundred forty-eighth equation into the one hundred forty-third equation, the following one hundred forty-ninth equation is obtained. The calculation of the k here includes the calculation of the n-th power root, but a lookup table for obtaining the n-th power root is stored in the memory 12 and referred to by the radar update unit F3. Thereby, it may be possible to easily execute the calculation. Then, the radar update unit F3 can obtain T by substituting the calculated k into the one hundred forty-eighth equation.

$$k = \frac{1}{{‖ {Δ}^{- 1} {R}_{ϕ}^{T} ( z - {x}_{c} ) ‖}_{n}} \qquad ( One Hundred Forty - Ninth Equation )$$

In the second embodiment, four hypotheses similar to those of the first embodiment are assumed. In the on-perimeter forward hypothesis and the on-perimeter reverse hypothesis, similarly to the first embodiment, it is necessary to determine whether the reflection position is on the facing side or on the back side. The radar update unit F3 performs a facing side/back side determination using the normal vector of the pseudo-rectangle PR at T, as represented by a one hundred fiftieth equation.

$$( One Hundred Fiftieth Equation )$$

$${d}_{τ} = \frac{\partial }{\partial {x}_{c}} {‖ {Δ}^{- 1} {R}_{ϕ}^{T} ( τ - {x}_{c} ) ‖}_{n}^{n} = {Δ}^{- 1} {{R}_{ϕ}^{T} ( {Δ}^{- 1} {R}_{ϕ}^{T} ( τ - {x}_{c} ) )}^{n - 1}$$

Specifically, when a condition of the following one hundred fifty-first expression (relation) is satisfied, the reflection position exists on the facing side. When a condition of a one hundred fifty-second expression is satisfied, the reflection position exists on the back side.

$${d}_{τ}^{T} τ < 0 \qquad ( One Hundred Fifty - First Equation )$$

$${d}_{τ}^{T} τ \geq 0 \qquad ( One Hundred Fifty - Second Equation )$$

Thus, by changing the ellipse to the pseudo-rectangle, tracking accuracy is improved, particularly in transient scenarios in which the target object OBJ briefly traverses the detection ranges of the image sensor 20 and the millimeter wave radar 30.

According to the second embodiment described above, in the update by the likelihood based on the point cloud, the outline model representing the outline shape of the target object for defining the correspondence between the observation point and the reflection source is set. Then, multiple correspondence hypotheses that are hypotheses according to multiple types of correspondence are set, and the image update target object state is further updated based on the multiple correspondence hypotheses. Here, the outline model is set to a pseudo-rectangular shape. In the outline model set to the pseudo-rectangular shape, the outline shape can be similar to the main target object shape such as the different vehicle. Therefore, it is possible to improve the accuracy of tracking.

### Other Embodiments

Although multiple embodiments have been described above, the present disclosure is not to be construed as being limited to these embodiments, and can be applied to various embodiments and combinations within a scope not deviating from the gist of the present disclosure.

In other embodiments, the image sensor 20 may capture images to the side or behind the vehicle EV, and the tracking device 10 may track target objects to the side or behind the vehicle EV.

As other embodiments, when at least one of the image sensor 20 or the millimeter wave radar 30 is provided, the tracking device 10 may fuse the multiple images acquired from the multiple image sensors 20 or the point clouds acquired from the multiple millimeter wave radars 30.

In predicting the target object state, the state prediction unit F1 may employ a Constant Turn Rate and Acceleration (CTRA) motion model instead of the CTRV motion model. The CTRA motion model is a model that assumes that the target object is moving at a constant angular velocity and a constant acceleration.

In other embodiments, the computer configuring the tracking device 10 may include a circuit such as an FPGA. A part of the process by the tracking device 10 may be implemented by the processor controlling the circuit based on a computer program or by the circuit operating independently.

What is claimed is:

1. A tracking device comprising
at least one of (i) a circuit and (ii) a processor with a memory storing computer program code executable by the processor, the at least one of the circuit and the processor configured to cause the tracking device to:
track a target object based on an image of the target object captured by an image sensor and a point cloud of an observation point at which the target object is observed by a radar to estimate a target object state;
calculate a prediction target object state by predicting the target object state at a second time later than a first time based on an estimation result of the target object state at the first time;
calculate an image update target object state by updating the prediction target object state using a first likelihood based on a recognition result of the image; and
update the image update target object state using a second likelihood based on the point cloud to obtain the estimation result of the target object state at the second time.

2. The tracking device according to claim 1, wherein
the at least one of the circuit and the processor is further configured to
model a likelihood function using an edge bearing of the target object in the recognition result of the image in update using the first likelihood based on an image recognition result, and
use the edge bearing being normalized by a distance to the target object in modeling the likelihood function.

3. The tracking device according to claim 1, wherein
the target object state includes a geometric parameter of the target object and a motion parameter of the target object, and
the at least one of the circuit and the processor is further configured to update the geometric parameter in update using the first likelihood based on the recognition result of the image, among the update using the first likelihood and update using the second likelihood.

4. The tracking device according to claim 1, wherein
a correspondence between the observation point and a reflection source has a plurality of types,
the at least one of the circuit and the processor is further configured to:
adopt an outline model representing an outline shape of the target object to define the correspondence between the observation point and the reflection source in update using the second likelihood based on the point cloud;
set a plurality of correspondence hypotheses according to the plurality of types of the correspondence; and
further update the image update target object state based on the plurality of correspondence hypotheses, and
the outline model is set to have elliptical shape.

5. The tracking device according to claim 1, wherein
a correspondence between the observation point and a reflection source has a plurality of types,
the at least one of the circuit and the processor is further configured to:
adopt an outline model representing an outline shape of the target object to define the correspondence between the observation point and the reflection source in update using the second likelihood based on the point cloud;
set a plurality of correspondence hypotheses according to the plurality of types of the correspondence; and
further update the image update target object state based on the plurality of correspondence hypotheses, and
the outline model is set to have a pseudo-rectangular shape.

6. The tracking device according to claim 1, wherein
the at least one of the circuit and the processor is further configured to:
determine whether the observation point is based on reflection from a facing side of the target object or the observation point is based on reflection from a back side of the target object in update using the second likelihood based on the point cloud; and
apply a different distribution to the target object state depending on whether the observation point is based on the reflection from the facing side or the back side.

7. A tracking method comprising:
tracking a target object based on an image of the target object captured by an image sensor and a point cloud of an observation point at which the target object is observed by a radar to estimate a target object state;
calculating a prediction target object state by predicting the target object state at a second time later than a first time based on an estimation result of the target object state at the first time;
calculating an image update target object state by updating the prediction target object state using a likelihood based on a recognition result of the image; and
updating the image update target object state using a second likelihood based on the point cloud to obtain the estimation result of the target object state at the second time.

8. A non-transitory computer-readable storage medium storing a tracking program configured to cause at least one processor to:
track a target object based on an image of the target object captured by an image sensor and a point cloud of an observation point at which the target object is observed by a radar to estimate a target object state;
calculate a prediction target object state by predicting the target object state at a second time later than a first time based on an estimation result of the target object state at the first time;
calculate an image update target object state by updating the prediction target object state using a likelihood based on a recognition result of the image; and
update the image update target object state using a second likelihood based on the point cloud to obtain the estimation result of the target object state at the second time.
